(19) United States
(12) Patent Application Publication
(10) Pub. No.: US 2026/0021459 A1
(43) Pub. Date: Jan. 22, 2026

(54) SUBSTRATE PROCESSING DEVICE, LIQUID SUPPLY DEVICE, AND SUBSTRATE PROCESSING METHOD

(71) Applicant: TOKYO OHKA KOGYO CO., LTD., Kawasaki-shi (JP)

(72) Inventors: Satoshi Fujimura, Kawasaki-shi (JP); Tomoya Kumagai, Hsinchu City (TW); Takayuki Haraguchi, Kawasaki-shi (JP); Hiroki Hiramatsu, Hillsboro, OR (US)

(21) Appl. No.: 19/252,556

(22) Filed: Jun. 27, 2025

Related U.S. Application Data
(60) Provisional application No. 63/672,115, filed on Jul. 16, 2024.

(51) Int. Cl. B01F 23/40; B01F 35/71; B01F 101/00; C09K 13/04

(52) U.S. Cl. CPC B01F 23/483; B01F 35/71805; C09K 13/04; B01F 2101/2204

(57) ABSTRACT

A substrate supporter that supports a substrate and a liquid supplier that supplies a liquid to a surface of the substrate supported by the substrate supporter. The liquid supplier supplies the substrate with a mixed solution prepared in a predetermined ratio of a main solution, pure water, and one or more of an additive, an oxidant, and an etching agent.

### RELATED APPLICATIONS

This application claims priority to U.S. Provisional Application No. 63/672, 115, filed Jul. 16, 2024, the entire content of which is incorporated herein by reference.

### TECHNICAL FIELD

The present invention relates to a substrate treatment apparatus, a liquid supply apparatus, and a substrate treatment method.

### BACKGROUND ART

For apparatuses that perform cleaning treatment or etching treatment on substrates, there are a dry system, which does not use any agent (chemical solution), and a wet system, which uses agents. In the wet system, the agent to be used is selected in accordance with the type of a substrate, the type of a film, contaminants and residues on the substrate, and the like. For the agent to be used, a plurality of agents may be mixed, which are used as a mixed solution. When the agents are mixed, the mixture is required to be prepared in consideration of the concentrations of the agents and the amounts of the agents to be used.

Patent Literature 1 and Patent Literature 2 describe the preparation of a removal solution to remove a silicon oxide film on a silicon substrate. Patent Literature 1 and Patent Literature 2 describe the preparation of a removal solution by mixing a removal solution stock solution, for which hydrogen fluoride is used, and inert gas-dissolved water. Patent Literature 3 describes a cleaning solution used in a regenerative cleaning unit to completely remove contaminants and the like on the substrate from the substrate surface. In Patent Literature 3 describes that an ammonia-hydrogen peroxide solution mixed solution, hydrogen fluoride (HF), a mixed solution of hydrogen fluoride (HF) mixed and nitric acid (HNO₃), buffered hydrofluoric acid (BHF), ammonium fluoride, a mixed solution of hydrofluoric acid and ethylene glycol (HFEG), and the like can be used as the cleaning soluton.

Patent Literature 4 describes an aqueous phosphoric acid solution containing silicon as an aqueous solution that selectively etches a silicon nitride film in a substrate with a silicon oxide film and a silicon nitride film exposed on the surface thereof. Patent Literature 5 describes a mixed solution to remove, from the substrate surface covered with a resist formed with a cured layer, the resist. Patent Literature 5 describes HF mixed SPM (a mixed solution of sulfuric acid and hydrogen peroxide). The HF mixed SPM is produced by mixing hydrogen peroxide (H₂O₂) and hydrogen fluoride (HF) in advance to produce a mixed solution and then adding sulfuric acid (H₂SO₄).

### CITATION LIST

### Patent Literature

[Patent Literature 1] Japanese Unexamined Patent Application Publication No. 2013-051264

[Patent Literature 2] Japanese Unexamined Patent Application Publication No. 2016-146505

[Patent Literature 3] Japanese Unexamined Patent Application Publication No. 2018-049918

[Patent Literature 4] Japanese Unexamined Patent Application Publication No. 2019-091815

[Patent Literature 5] Japanese Unexamined Patent Application Publication No. 2016-181677

### SUMMARY OF INVENTION

### Technical Problem

Patent Literature 1 to Patent Literature 5 describe mixed solution with a plurality of agents mixed as the cleaning solution and the etching solution, but do not describe any advantages of making the agent composition freely. If the agent composition can be prepared freely, even when changing the cleaning solution and the etching solution, users can easily and quickly address the preparation. Furthermore, users who have purchased agents can improve the efficiency of substrate treatment if the users themselves can control the exact agent composition. Therefore, a proposal that can make the agent composition freely is being desired in substrate treatment apparatuses or liquid supply apparatuses.

An object of the present invention is to provide a substrate treatment apparatus, a liquid supply apparatus, and a substrate treatment method that can, when a mixed solution required for cleaning treatment or etching treatment on a substrate is produced, easily prepare the mixture composition.

### Solution to Problem

An aspect of the present invention provides a substrate treatment apparatus including: a substrate supporter that supports a substrate; and a liquid supplier that supplies a liquid to a surface of the substrate supported by the substrate supporter, in which the liquid supplier supplies the substrate with a mixed solution prepared in a predetermined ratio of a main solution, pure water, and one or more agents selected from among an additive, an oxidant, and an etching agent.

An aspect of the present invention provides a liquid supply apparatus that supplies a liquid to a surface of a substrate supported by a substrate supporter, in which the liquid supply apparatus supplies the substrate with a mixed solution prepared in a predetermined ratio of a main solution, pure water, and one or more agents selected from among an additive, an oxidant, and an etching agent.

An aspect of the present invention provides a substrate treatment method including: producing a mixed solution prepared in a predetermined ratio of a main solution, pure water, and one or more agents selected from among an additive, an oxidant, and an etching agent; and supplying the mixed solution to a substrate supported by a substrate supporter.

### Advantageous Effects of Invention

According to the aspects of the present invention, when the mixed solution required for cleaning treatment or etching treatment on the substrate is produced, the composition of the mixed solution can be easily prepared. As a result, the use of the optimum mixture for the treatment of the substrate can improve cleaning power and etching selectivity to the substrate and improve the efficiency of treating the substrate. In addition, in semiconductor production, even if there are changes of user's demands about residues (substances to be removed) on the substrate, an etching target, etching selectivity, and the like due to changes of process nodes, integration, and the like, the mixture can be easily prepared in the apparatus.

### BRIEF DESCRIPTION OF THE DRAWINGS

FIG. 1 is a schematic diagram of an example of a substrate treatment apparatus according to a first embodiment.

FIG. 2 is a diagram of an example of a first container to a fourth container of the substrate treatment apparatus according to the first embodiment.

FIG. 3 is a diagram of the main part of an example of a substrate treatment apparatus according to a second embodiment.

FIG. 4 is a diagram of a state in which a plurality of types of main solutions are prepared in an example of a substrate treatment apparatus according to a third embodiment.

FIG. 5 is a diagram of a state in which a plurality of types of additives are prepared in an example of the substrate treatment apparatus according to the third embodiment.

FIG. 6 is a diagram of a state in which a plurality of types of oxidants are prepared in an example of the substrate treatment apparatus according to the third embodiment.

FIG. 7 is a diagram of a state in which a plurality of types of etching agents are prepared in an example of the substrate treatment apparatus according to the third embodiment.

FIG. 8 is a diagram of a buffer tank as an example of a mixer.

FIG. 9 is a diagram of an overview of a mixing valve as an example of the mixer.

FIG. 10 is a diagram of the details of mixing the main solution, the additive, the oxidant, the etching agent, and pure water by mixing valves.

FIG. 11 is a diagram of the main part of an example of a substrate treatment apparatus according to a fourth embodiment.

FIG. 12 is a flowchart including an example of a substrate treatment method according to an embodiment.

### DESCRIPTION OF EMBODIMENTS

The following describes embodiments of the present invention with reference to the accompanying drawings. However, the present invention is not limited to the details described below. The drawings illustrate some parts in an enlarged or highlighted manner or some parts in a simplified or omitted manner in order to make the components of the embodiments easy to understand, and the actual structure, shape, scale, and the like may differ.

### Substrate Treatment Apparatus

### First Embodiment

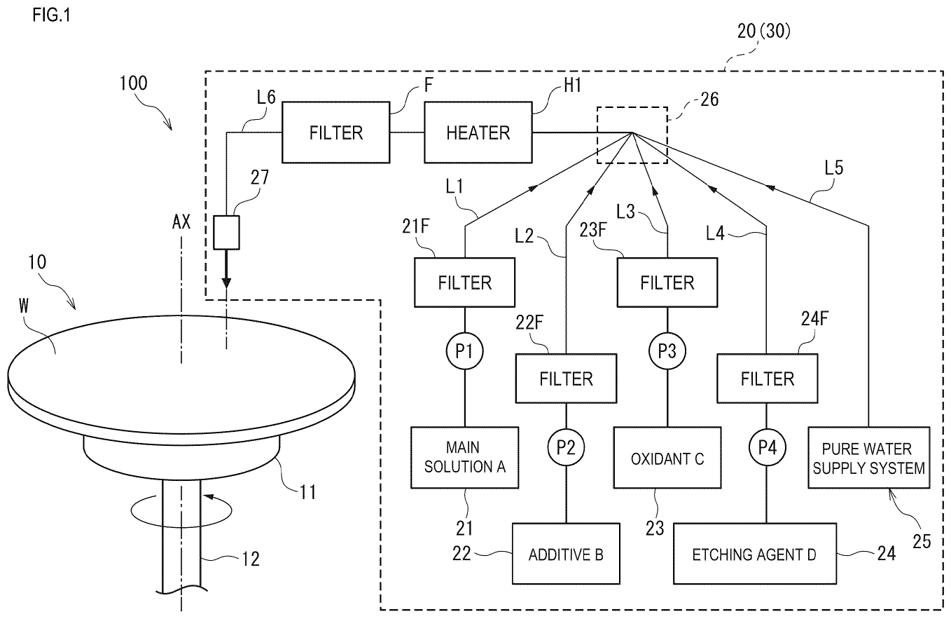

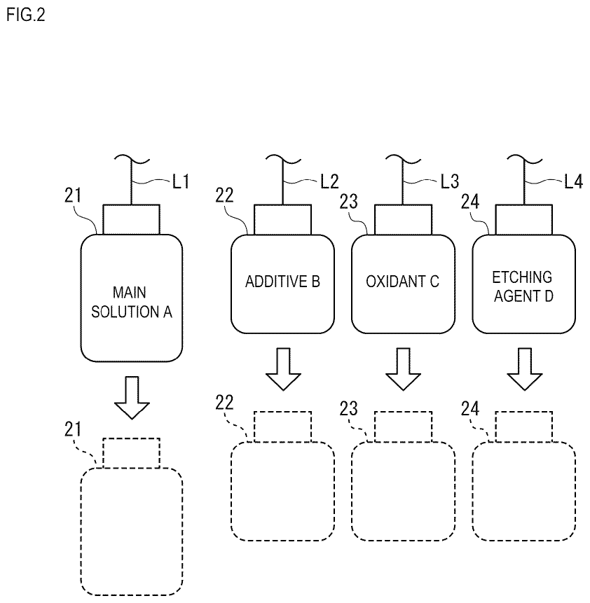

FIG. 1 is a schematic diagram of an example of a substrate treatment apparatus according to a first embodiment, and FIG. 2 is a diagram of an example of a first container 21 to a fourth container 24 of the substrate treatment apparatus according to the first embodiment. This substrate treatment apparatus 100 is, for example, a substrate cleaning apparatus, an etching apparatus, and the like. In the present example, the substrate treatment apparatus 100 is a substrate cleaning apparatus. As illustrated in FIG. 1, the substrate treatment apparatus 100 includes a substrate supporter 10 and a liquid supplier 20. The substrate supporter 10 includes a table 11 and a rotary shaft 12. The substrate supporter 10 is, for example, a spinner chuck that sucks the underside of a substrate W to hold the substrate W. The substrate W may be circular in shape or rectangular in shape.

The table 11 holds and supports the substrate W from the underside of the substrate W by a sucker (not shown) in a sucked manner such that the substrate W is horizontal. The table 11 is provided at the upper end of the rotary shaft 12 and rotates about a rotary axis AX when the rotary shaft 12 rotates. The rotary shaft 12 is connected to a drive source (not shown), and when the drive source is driven, the rotary shaft 12 rotates to rotate the table 11 and the substrate W held on the table 11 in a sucked manner.

The liquid supplier 20 includes the first container 21, the second container 22, the third container 23, the fourth container 24, a pure water supply system 25, a mixer 26, a discharge nozzle 27, a heater H1, and a filter F. The first container 21 contains a main solution A. The second container 22 contains an additive B. The third container 23 contains an oxidant C. The fourth container 24 contains an etching agent D. Note that the “third container” and the “fourth container” are ones of the second container, and are referred to as “third container” and “fourth container” in the present embodiment in order to distinguish them from the other second container. For the materials of the first container 21, the second container 22, the third container 23, and the fourth container 24, materials that enable appropriate storage for agents (chemical solutions) to be contained in the containers and have chemical resistance thereto are used.

The shape and the size of the materials of the first container 21, the second container 22, the third container 23, and the fourth container 24 can be designed as appropriate in accordance with the locations of installation and the amounts of the agents to be used. As shown by the dotted lines in FIG. 2, the first container 21, the second container 22, the third container 23, and the fourth container 24 are freely replaceable, and at least one container may be replaceable, or all the containers may be replaceable. Each container is replaceable, so that the user can flexibly perform the preparation of agents in accordance with the usage of each agent.

Examples of the main solution A include a solution containing components such as pure water, an organic solvent, a pH adjuster, a corrosion inhibitor, a chelating agent, a surfactant, and a reaction accelerator or the like. The main solution A may be a mixed solution in which chemical solution components such as pure water, an organic solvent, a pH adjuster, a corrosion inhibitor, a chelating agent, a surfactant, and a reaction accelerator or the like are mixed in any ratio. Furthermore, if a mixed solution in which the additive B is mixed with the main solution A is stored in the first container 21, the second container 22 that contains the additive B may be purposely omitted. When mixing, at least two or more chemical solutions of the main solution A, the additive B, the oxidant C, the etching agent D, and the pure water are mixed. As to the mixing ratio, each component can be mixed at 1:1,000 to 2,000, and the mixed solution can be produced at any ratio falling under this mixing ratio.

For example, it is possible to produce a mixed solution with the main solution A:the additive B:the oxidant C:the etching agent D:the pure water being 1 to 100:0 to 100:0.1 to 100:0.1 to 100:1 to 100. Note that the concentration of the main solution A, the additive B, the oxidant C, and the etching agent D is not a concentration when the entire mixed solution is 100, but the concentration of a mixed solution obtained by mixing the agents at any concentration and diluted with the pure water, and the mixed solution of this concentration can be used. Examples of the pure water, the organic solvent, the pH adjuster, the corrosion inhibitor, the chelating agent, the surfactant, and the reaction accelerator include known substances. Examples of the pure water include purified water, ion exchanged water, and distilled water.

Examples of the organic solvent include water-soluble substances such as alcohols and glycol ethers. It may also be an aprotic polar solvent. Examples thereof include dimethyl sulfoxide (DMSO), tetrahydrofuran (THE), and dimethylformamide (DMF).

As the pH adjuster, generally known substances can be used, and examples thereof include substances such as inorganic acids, organic acids, inorganic alkalis, and organic alkalis.

The corrosion inhibitor is not limited to a particular one, and examples thereof include compounds including a nitrogen-containing heterocyclic ring such as a triazole ring, an imidazole ring, a pyridine ring, a phenanthroline ring, a tetrazole ring, a pyrazole ring, a pyrimidine ring, and a purine ring.

Examples of the chelating agent include a tetrasodium 1-hydroxyethane-1,1-diphosphonate solution, ethylenediaminetetraacetic acid, hydroxyethyl ethylenediaminetriacetic acid, etidronic acid, ethylenediamine disuccinic acid, edetic acid, citric acid, gluconic acid, glutamic diacetic acid, diethylenetriamine pentaacetic acid, hydroxyethane diphosphonic acid, hydroxyethyl ethylenediaminetriacetic acid, phytic acid, hexametaphosphoric acid, pentetic acid, and metaphosphoric acid, and sodium salts of these chelating agents are also acceptable.

Examples of the surfactant include nonionic surfactants, anionic surfactants, cationic surfactants, and amphoteric surfactants. As the reaction accelerator, known substances can be used.

The additive B may be, for example, an agent that can be adjusted in concentration independently separately from the component of the main solution A and enables further adjustment of properties. The additive B contains one or more of an organic solvent, a pH adjuster, a corrosion inhibitor, a chelating agent, a surfactant, and a reaction accelerator or the like. For the organic solvent, the pH adjuster, the corrosion inhibitor, the chelating agent, the surfactant, and the reaction accelerator, the same agents as the agent components in the main solution A described above can be used. Separately from the main solution A, the additive B of a lower concentration, for example, about ppm can be produced by performing independent concentration adjustment and further performing dilution with, for example, pure water in the mixer 26. The additive B may also be prepared in a state of being diluted with the main solution A.

The oxidant C contains either a peroxide or an oxoacid. Examples of the peroxide include hydrogen peroxide, peracetic acid, and other commonly known peroxides. Examples of the oxoacid include nitric acid, potassium nitrate, cerium ammonium nitrate, permanganate, hypochlorous acid, chlorous acid, chloric acid, perchloric acid, hypobromous acid, bromous acid, bromic acid, perbromic acid, chromic acid, dichromic acid, hypoiodous acid, iodous acid, iodic acid, periodic acid, phosphorous acid, phosphoric acid, sulfurous acid, sulfuric acid, sulfonic acid, sulfinic acid, and other commonly known oxoacids. The oxidant C can be adjusted in concentration independently. The concentration of the oxidant C may also be adjusted by dilution with the main solution A, for example, pure water.

The etching agent D contains at least one of a hydrogen halide, a hydrogen halide compound, and a base compound. Examples of the hydrogen halide include hydrogen fluoride, hydrochloric acid, hydrogen bromide, and hydrogen iodide. Examples of the hydrogen halide compound include hexafluorosilicic acid.

Examples of the base compound include ammonium fluoride and tetramethylammonium fluoride. The etching agent D can be adjusted in concentration independently. The concentration of the etching agent D may also be adjusted by dilution with the main solution A, for example, pure water as in the oxidant C.

The pure water supply system 25 contains pure water Wa inside the system. Examples of the pure water Wa include the same pure water as the pure water used for the main solution A. The pure water supply system 25 may have a known pure water production apparatus inside and may be configured to supply the produced pure water Wa. The pure water Wa may be purchased, and the system may also be configured to supply the purchased pure water Wa. Inside the system, a pump, a filter, and an adjuster that adjusts the flow of the pure water Wa when supplying the pure water Wa, which are not shown, are provided. Note that for the pump and the filter, known pumps and filters can be used.

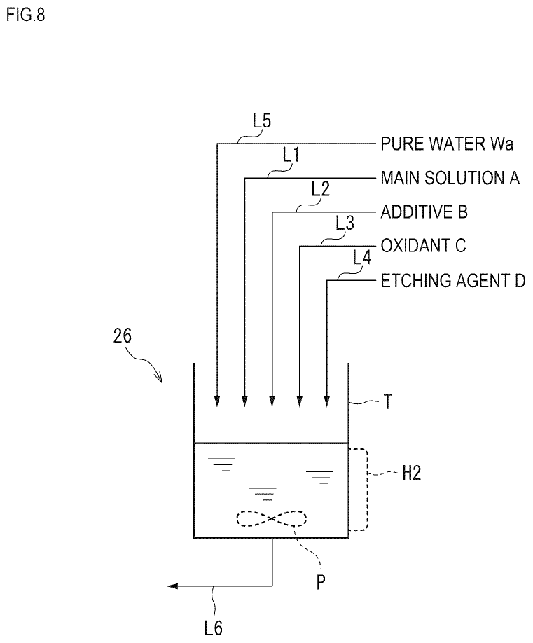

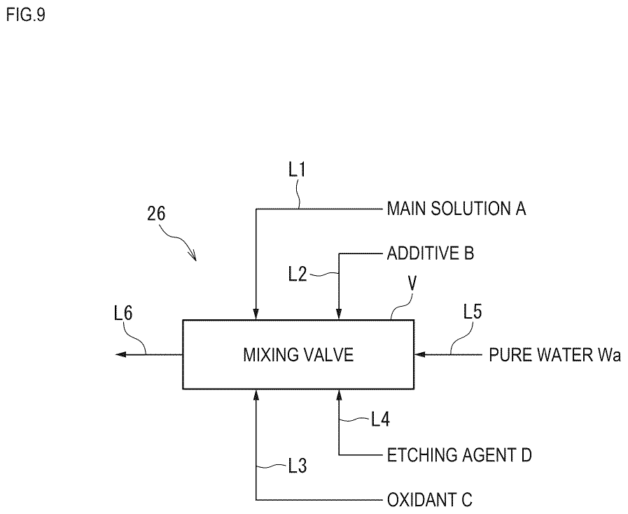

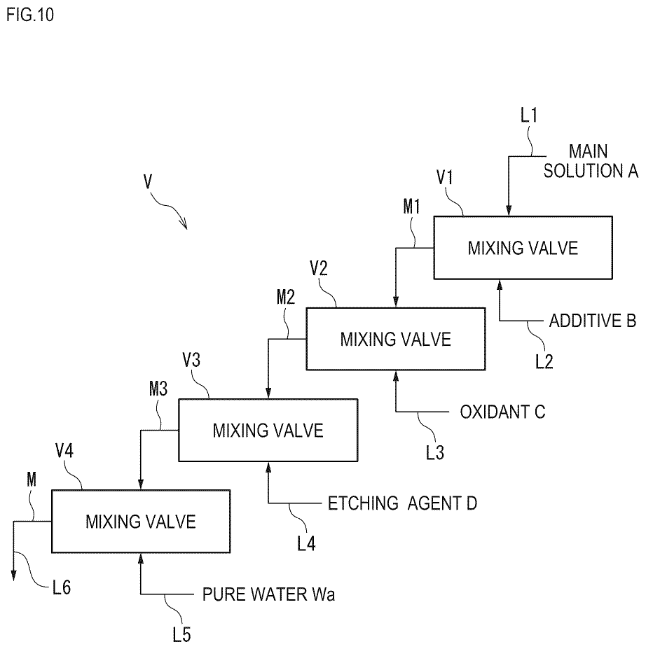

The mixer 26 prepares (mixes) the main solution A, one or more agents selected from among the additive B, the oxidant C, and the etching agent D, and the pure water Wa in a predetermined ratio to produce a mixed solution. Examples of the mixer 26 include a buffer tank T (refer to FIG. 8) and a mixing valve V (refer to FIG. 9 and FIG. 10), which will be described later. The mixer 26 and the first container 21 are coupled to each other with a main solution supply line L1, and the main solution A is supplied to the mixer 26 in a predetermined concentration and a predetermined amount via the main solution supply line L1.

On the main solution supply line L1, a pump P1 and a filter 21F are provided, and the main solution A is supplied to the mixer 26 in the predetermined concentration and the predetermined amount with impurities removed. The mixer 26 and the second container 22 are coupled to each other with an additive supply line L2, and the additive B is supplied to the mixer 26 in a predetermined concentration and a predetermined amount via the additive supply line L2. On the additive supply line L2, a pump P2 and a filter 22F are provided, and the additive B is supplied to the mixer 26 in the predetermined concentration and the predetermined amount with impurities removed.

The mixer 26 and the third container 23 are coupled to each other with an oxidant supply line L3, and the oxidant C is supplied to the mixer 26 in a predetermined concentration and a predetermined amount via the oxidant supply line L3. On the oxidant supply line L3, a pump P3 and a filter 23F are provided, and the oxidant C is supplied to the mixer 26 in the predetermined concentration and the predetermined amount with impurities removed. The mixer 26 and the fourth container 24 are coupled to each other with an etching agent supply line L4, and the etching agent D is supplied to the mixer 26 in a predetermined concentration and a predetermined amount via the etching agent supply line L4.

On the etching agent supply line L4, a pump P4 and a filter 24F are provided, and the etching agent D is supplied to the mixer 26 in the predetermined concentration and the predetermined amount with impurities removed. The mixer 26 and the pure water supply system 25 are coupled to each other with a pure water supply line L5, and the pure water Wa is supplied to the mixer 26 in a predetermined amount via the pure water supply line L5. Inside the pure water supply system 25, the adjuster (not shown) that adjusts the flow of the pure water Wa is provided, which supplies the pure water Wa to the mixer 26 in the predetermined amount. For the pumps and filters used for the pumps P1 to P4 and the filters 21F to 24F, known pumps and filters can be used.

By containing the main solution A, the additive B, the oxidant C, the etching agent D, and the pure water in the first container 21, the second container 22, the third container 23, the fourth container 24, and the pure water supply system 25, respectively, the concentration of each agent can be independently adjusted by the user. As a result, the concentration of each agent can be properly controlled when the mixed solution is finally prepared. The first container 21 can be detached from the main solution supply line L1. The second container 22 can be detached from the additive supply line L2. The third container 23 can be detached from the oxidant supply line L3. The fourth container 24 can be detached from the etching agent supply line L4.

Thus, the first container 21, the second container 22, the third container 23, and the fourth container 24 have respective standardized shapes, and thus the first container 21, the second container 22, the third container 23, and the fourth container 24 can each be replaced. As a result, when the main solution A, the additive B, the oxidant C, and the etching agent D are refilled, simple operations such as replacing the first container 21, the second container 22, the third container 23, and the fourth container 24 allow the main solution A, the additive B, the oxidant C, and the etching agent D to be refilled. Note that the first container 21, the second container 22, the third container 23, and the fourth container 24 illustrated are examples, and containers of different shapes from those illustrated may be used. For the first container 21, the second container 22, the third container 23, and the fourth container 24, containers of the same shape may be used or containers of different shapes may be used.

The discharge nozzle 27 supplies the mixed solution produced in the mixer 26 to the upper surface of the rotating substrate W. The supplied mixed solution spreads over the entire surface of the rotating substrate W, and then the substrate W is subjected to etching treatment or cleaning treatment. For the discharge nozzle 27, known discharge nozzles are used, and examples thereof include spray discharge nozzles.

The discharge nozzle 27 and the mixer 26 are coupled to each other with a mixed solution supply line L6, and the mixed solution produced in the mixer 26 is sent to the discharge nozzle 27 via the mixed solution supply line L6. On the mixed solution supply line L6, the heater H1 and the filter F are provided, and the mixed solution heated to an appropriate temperature with impurities removed is sent to the discharge nozzle 27. The heating temperature of the mixed solution can be set as appropriate in accordance with the types of the agents being mixed or other conditions. For the heater H1 and the filter F used, known heaters and filters can be used.

### Second Embodiment

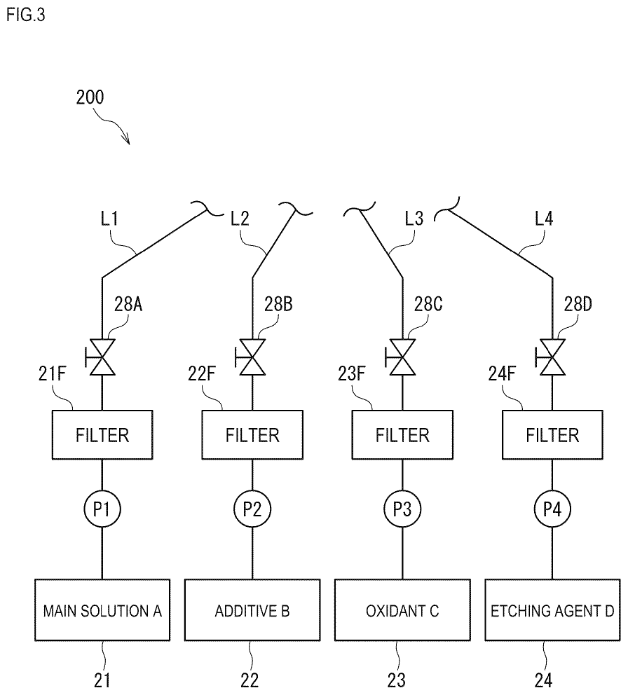

FIG. 3 is a diagram of the main part of a substrate treatment apparatus 200 according to a second embodiment. The same components as those of the first embodiment are denoted by the same symbols, descriptions of the components are omitted, and parts different from those of the first embodiment are mainly described. As illustrated in FIG. 3, in the present embodiment, a first flow adjuster 28A, a second flow adjuster 28B, a third flow adjuster 28C, and a fourth flow adjuster 28D are provided on the main solution supply line L1, the additive supply line L2, the oxidant supply line L3, and the etching agent supply line L4, respectively. Note that the “third flow adjuster” and the “fourth flow adjuster” are ones of the second flow adjuster, and are referred to as “third flow adjuster” and “fourth flow adjuster” in the present embodiment in order to distinguish them from the other second flow adjuster. FIG. 3 omits the illustration of the pure water supply system 25 and the pure water supply line L5, but as described above, the pump, the filter, and the adjuster that adjusts the flow of the pure water Wa when supplying the pure water Wa, which are not shown, are provided inside the pure water supply system 25. The adjuster that adjusts the flow of the pure water Wa has the same function as that of the first flow adjuster 28A, the second flow adjuster 28B, the third flow adjuster 28C, and the fourth flow adjuster 28D.

The first flow adjuster 28A sets the flow per unit time of the main solution A and adjusts the supply amount to the mixer 26. The second flow adjuster 28B sets the flow per unit time of the additive B and adjusts the supply amount to the mixer 26. The third flow adjuster 28C sets the flow per unit time of the oxidant C and adjusts the supply amount to the mixer 26. The fourth flow adjuster 28D sets the flow per unit time of the etching agent D and adjusts the supply amount to the mixer 26.

The first flow adjuster 28A, the second flow adjuster 28B, the third flow adjuster 28C, and the fourth flow adjuster 28D adjust the main solution A, the additive B, the oxidant C, and the etching agent D in a predetermined ratio to adjust the supply amount to the mixer 26 on the basis of the mixing ratio of each agent determined in advance in order to produce the mixed solution in the mixer 26. The adjustment of the supply amount may be done by programmed control or done manually.

By providing the first flow adjuster 28A, the second flow adjuster 28B, the third flow adjuster 28C, and the fourth flow adjuster 28D, the user can easily set the mixing ratio of each agent and produce a mixed solution having an appropriate mixing ratio. The first flow adjuster 28A, the second flow adjuster 28B, the third flow adjuster 28C, and the fourth flow adjuster 28D are, for example, flow adjustment valves; globe valves, needle valves, gate valves, solenoid valves, and other known valves can be used. On the basis of the mixing ratio to produce the mixed solution in the mixer 26, the supply amount to the mixer 26 is adjusted to produce the mixed solution.

### Third Embodiment

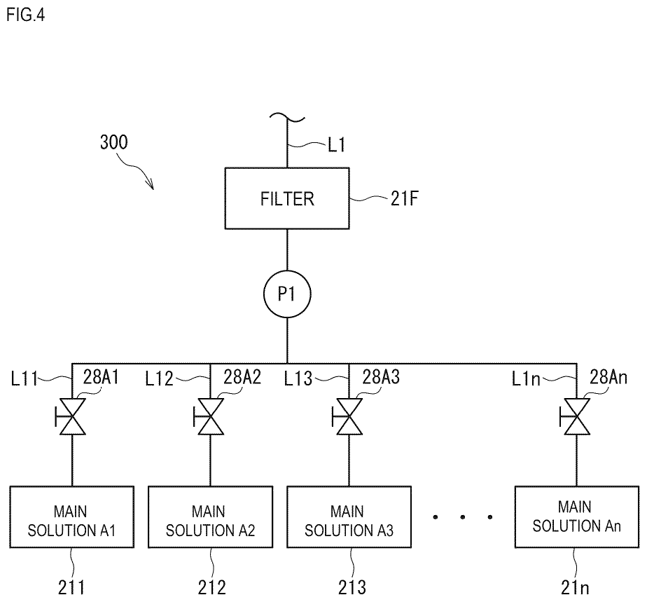

FIG. 4 to FIG. 7 are diagrams of the main part of a substrate treatment apparatus 300 according to a third embodiment. Note that the same components as those of the first embodiment and the second embodiment are denoted by the same symbols, descriptions of the components are omitted, and parts different from those of the first embodiment and the second embodiment are mainly described. FIG. 4 is a diagram of a state in which a plurality of types of main solutions in an example of the substrate treatment apparatus 300 according to the third embodiment are prepared as a main solution A1, a main solution A2, a main solution A3, . . . , and a main solution An of different types. One or more of the main solutions A can be selected. The main solution A1, the main solution A2, the main solution A3, . . . , and the main solution An are contained in first containers 211, 212, 213, . . . , and 21n, respectively.

The main solution A1, the main solution A2, the main solution A3, . . . , and the main solution An may be contained in all or any of the first containers 211, 212, 213, . . . , and 21n as different types of main solutions, that is, mixed solutions with different agents mixed in a predetermined mixing ratio. Only one agent may be contained in any first container of the first containers 211, 212, 213, . . . , and 21n as an agent adjusted to a predetermined concentration. Note that, even when having the same agents mixed therein, main solutions are different in type if the mixing ratios are different.

The first containers 211, 212, 213, . , , , and 21n are coupled to the main solution supply line L1 with branch main solution supply lines L11, L12, L13, . . . , and L1n. The main solution A1, the main solution A2, the main solution A3, . . . , and the main solution An are supplied to the main solution supply line L1 via the branch main solution supply lines L11, L12, L13, . . . , and L1n. On the branch main solution supply lines L11, L12, L13, . . . , and L1n, first flow adjusters 28A1, 28A2, 28A3, . . . , and 28An, which have the same function as that of the first flow adjuster 28A in the second embodiment, are provided.

This makes it possible to select one or more main solutions to be supplied to the main solution supply line L1. For example, when the main solution A1 and the main solution A2 are supplied to the main solution supply line L1, the first flow adjusters 28A1 and 28A2 are open and the other first flow adjusters 28A3, . . . , and 28An are closed. By preparing different main solutions that can be selected, a variety of mixed solutions of different types in terms of concentration and mixing ratio can be produced in the mixer 26.

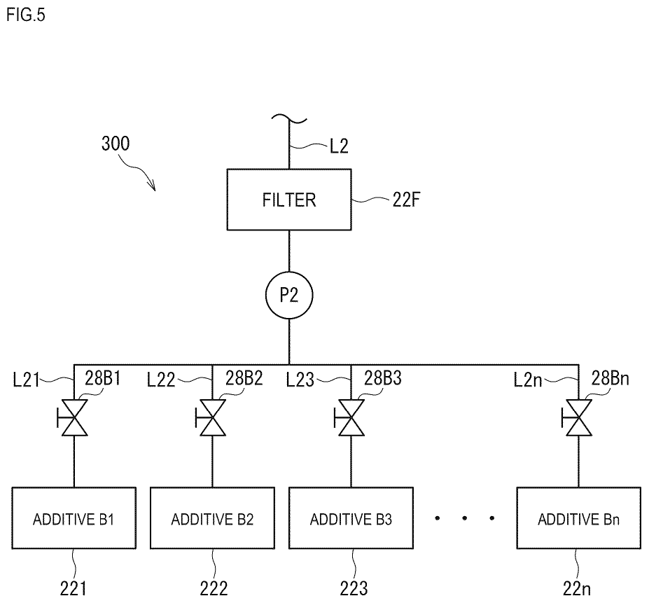

FIG. 5 is a diagram of a state in which a plurality of types of additives in an example of the substrate treatment apparatus 300 according to the third embodiment are prepared as an additive B1, an additive B2, an additive B3, . . . , and an additive Bn of different types. One or more of the additives B can be selected. The additive B1, the additive B2, the additive B3, . . . , and the additive Bn are contained in second containers 221, 222, 223, . . . , and 22n, respectively. The additive B1, the additive B2, the additive B3, . . . , and the additive Bn are different types of additives.

The additive may be a mixed additive produced by mixing additives in a predetermined mixing ratio or may be only one type of additive. Additives of the same type but having different concentrations are different types of additives. All the second containers 221, 222, 223, . . . , and 22n may contain the mixed additive, or all the second containers 221, 222, 223, . . . , and 22n may contain the only one type of additive. Furthermore, at least one of the second containers 221, 222, 223, . . . , and 22n may contain the only one type of additive and the remaining second containers may contain the mixed additives.

The second containers 221, 222, 223, . . . , and 22n are coupled to the additive supply line L2 with branch additive supply lines L21, L22, L23, . . . , and L2n. The additive B1, the additive B2, the additive B3, . . . , and the additive Bn are supplied to the additive supply line L2 via the branch additive supply lines L21, L22, L23, . . . , and L2n.

On the branch additive supply lines L21, L22, L23, . . . , and L2n, second flow adjusters 28B1, 28B2, 28B3, . . . , and 28Bn, which have the same function as that of the second flow adjuster 28B in the second embodiment, are provided. This makes it possible to select one or more additives to be supplied to the additive supply line L2. For example, when the additive B1 and the additive B2 are supplied to the additive supply line L2, the second flow adjusters 28B1 and 28B2 are open and the other second flow adjusters 28B3, . . . , and 28Bn are closed. By preparing different additives that can be selected, a variety of mixed solutions of different types in terms of concentration and mixing ratio can be produced in the mixer 26.

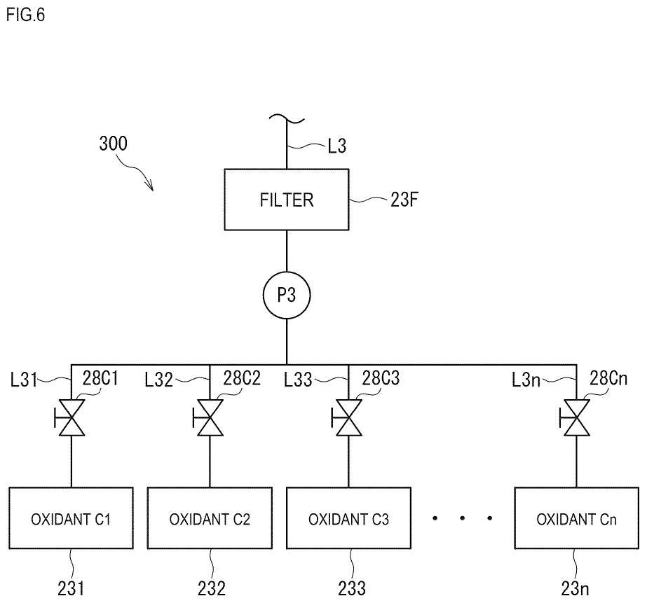

FIG. 6 is a diagram of a state in which a plurality of types of oxidants in an example of the substrate treatment apparatus 300 according to the third embodiment are prepared as an oxidant C1, an oxidant C2, an oxidant C3, . . . , and an oxidant Cn of different types. One or more of the oxidants C can be selected. The oxidant C1, the oxidant C2, the oxidant C3, . . . , and the oxidant Cn are contained in third containers 231, 232, 233, . . . , and 23n, respectively. The oxidant C1, the oxidant C2, the oxidant C3, . . . , and the oxidant Cn are different types of oxidants. Oxidants of the same type but having different concentrations are different types of oxidants.

The third containers 231, 232, 233, . . . , and 23n are coupled to the oxidant supply line L3 with branch oxidant supply lines L31, L32, L33, . . . , and L3n. The oxidant C1, the oxidant C2, the oxidant C3, . . . , and the oxidant Cn are supplied to the oxidant supply line L3 via the branch oxidant supply lines L31, L32, L33, . . . , and L3n.

On the branch oxidant supply lines L31, L32, L33, . . . , and L3n, third flow adjusters 28C1, 28C2, 28C3, . . . , and 28Cn, which have the same function as that of the third flow adjuster 28C in the second embodiment, are provided. This makes it possible to select one or more oxidants to be supplied to the oxidant supply line L3. For example, when the oxidant C1 and the oxidant C2 are supplied to the oxidant supply line L3, the third flow adjusters 28C1 and 28C2 are open and the other third flow adjusters 28C3, . . . , and 28Cn are closed. By preparing different oxidants that can be selected, a variety of mixed solutions of different types in terms of concentration and mixing ratio can be produced in the mixer 26.

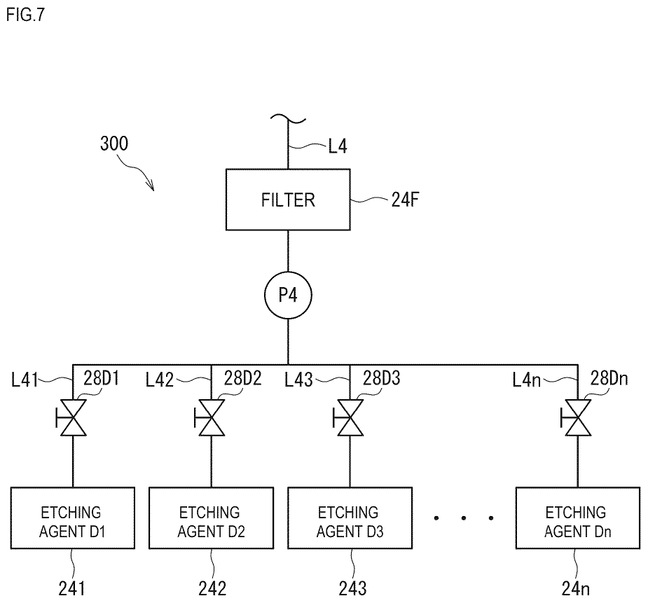

FIG. 7 is a diagram of a state in which a plurality of types of etching agents in an example of the substrate treatment apparatus 300 according to the third embodiment are prepared as an etching agent D1, an etching agent D2, an etching agent D3, . . . , and an etching agent Dn of different types. One or more of the etching agents D can be selected. The etching agent D1, the etching agent D2, the etching agent D3, . . . , and the etching agent Dn are contained in fourth containers 241, 242, 243, . . . , and 24n, respectively. The etching agent D1, the etching agent D2, the etching agent D3, . . . , and the etching agent Dn are different types of etching agents. Etching agents of the same type but having different concentrations are different types of etching agents.

The fourth containers 241, 242, 243, . . . , and 24n are coupled to the etching agent supply line L4 with branch etching agent supply lines L41, L42, L43, . . . , and L4n. The etching agent D1, the etching agent D2, the etching agent D3, . . . , and the etching agent Dn are supplied to the etching agent supply line L4 via the branch etching agent supply lines L41, L42, L43, . . . , and L4n.

On the branch etching agent supply lines L41, L42, L43, . . . , and L4n, fourth flow adjusters 28D1, 28D2, 28D3, . . . , and 28Dn, which have the same function as that of the fourth flow adjuster 28D in the second embodiment, are provided. This makes it possible to select one or more etching agents to be supplied to the etching agent supply line L4. For example, when the etching agent D1 and the etching agent D2 are supplied to the etching agent supply line L4, the fourth flow adjusters 28D1 and 28D2 are open and the other fourth flow adjusters 28D3, . . . , and 28Dn are closed. By preparing different etching agents that can be selected, a variety of mixed solutions of different types in terms of concentration and mixing ratio can be produced in the mixer 26.

FIG. 8 is a diagram of the buffer tank T as an example of the mixer 26. The buffer tank T is an apparatus that mixes the main solution A, the additive B, the oxidant C, the etching agent D, and the pure water Wa in predetermined concentrations and predetermined amounts supplied from the main solution supply line L1, the additive supply line L2, the oxidant supply line L3, the etching agent supply line L4, and the pure water supply line L5, respectively, to produce a mixed solution with the agents uniformly mixed.

In the buffer tank T, the mixed solution is produced in advance before supply to the substrate W. The buffer tank T has a cylindrical shape with a bottom and an open top. The shape is not limited to a cylindrical shape, but may also be a box-shaped, rectangular prism. For the material of the buffer tank T, known materials can be used so long as they are materials having corrosion resistance to the agents to be charged. Examples thereof include stainless steel, titanium alloys, and the like.

The buffer tank T includes a stirrer P and a heater H2. The stirrer P stirs the main solution A, the additive B, the oxidant C, the etching agent D, and the pure water Wa supplied to the buffer tank T to make a uniform mixed solutions. Examples of the stirrer P include a propeller blade, a paddle blade, and the like as a stirring blade. The propeller blade, the paddle blade, or the like includes a rotary shaft (not shown) coupled to its central part and rotates when a motor (not shown) on which the rotary shaft is mounted is driving. The heater H2 is provided on part of the side of the buffer tank T and is connected to a heat source (not shown) to heat the mixed solution inside to a certain temperature.

Note that, when the heater H1 is provided on the mixed solution supply line L6, the heater H2 does not necessarily have to be provided in the buffer tank T. The bottom of the buffer tank T is coupled to the mixed solution supply line L6, and the mixed solution in the buffer tank T is delivered to the mixed solution supply line L6.

FIG. 9 is a diagram of an overview of the mixing valve V as an example of the mixer 26, and FIG. 10 is a diagram of the details of mixing the main solution A, the additive B, the oxidant C, the etching agent D, and the pure water Wa by the mixing valves V. The mixing valve V is an apparatus that adjusts the mixing ratio of the main solution A, the additive B, the oxidant C, the etching agent D, and the pure water Wa in predetermined concentrations and predetermined amounts supplied from the main solution supply line L1, the additive supply line L2, the oxidant supply line L3, the etching agent supply line L4, and the pure water supply line L5, respectively, to produce a mixed solution with the agents uniformly mixed. In the mixing valve V, the mixed solution is produced in advance before supply to the substrate W. Note that for the mixing valve V, known mixing valves can be used.

As illustrated in FIG. 10, the mixing valve V includes mixing valves V1, V2, V3, and V4. The mixing valve V1 mixes the main solution A and the additive B supplied from the main solution supply line L1 and the additive supply line L2 to produce a mixed solution M1. The mixing valve V2 mixes the mixed solution M1 produced in the mixing valve V1 and the oxidant C supplied from the oxidant supply line L3 to produce a mixed solution M2.

The mixing valve V3 mixes the mixed solution M2 produced in the mixing valve V2 and the etching agent D supplied from the etching agent supply line L4 to produce a mixed solution M3. The mixing valve V4 mixes the mixed solution M3 produced in the mixing valve V3 and the pure water Wa supplied from the pure water supply line L5 to produce a mixed solution M. The mixing valve V4 is coupled to the mixed solution supply line L6, and the mixed solution M is finally delivered to the mixed solution supply line L6 as a mixed solution of the main solution A, the additive B, the oxidant C, the etching agent D, and the pure water Wa.

### Fourth Embodiment

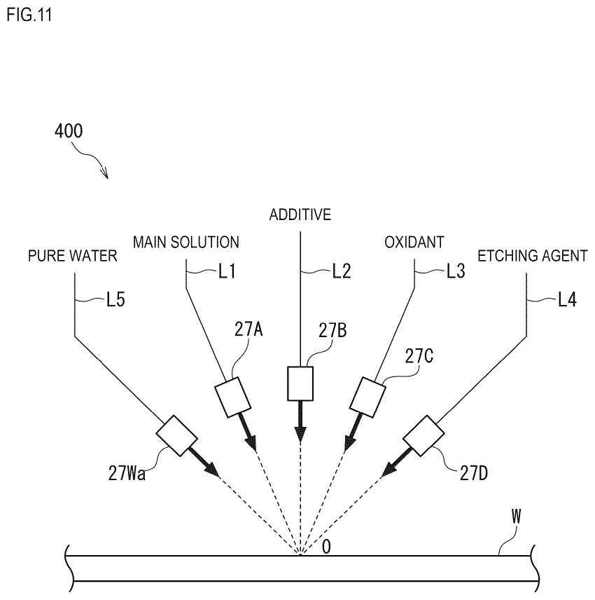

FIG. 11 is a diagram of the main part of a substrate treatment apparatus 400 according to a fourth embodiment. Note that the same components as those of the first embodiment to the third embodiment are denoted by the same symbols, descriptions of the components are omitted, and parts different from those of the first embodiment to the third embodiment are mainly described. In the present embodiment, the main solution supply line L1, the additive supply line L2, the oxidant supply line L3, the etching agent supply line L4, and the pure water supply line L5 are coupled to discharge nozzles 27A, 27B, 27C, 27D, and 27Wa corresponding to the respective supply lines.

The main solution A, the additive B, the oxidant C, the etching agent D, and the pure water Wa in predetermined concentrations and predetermined amounts are supplied from the main solution supply line L1, the additive supply line L2, the oxidant supply line L3, the etching agent supply line L4, and the pure water supply line L5, respectively, to the discharge nozzles 27A, 27B, 27C, 27D, and 27Wa corresponding to the respective supply lines, and are supplied toward a central part O of the substrate W. The main solution A, the additive B, the oxidant C, the etching agent D, and the pure water Wa are mixed at the central part O of the substrate W to form a mixed solution, which spreads over the entire surface of the substrate W by the centrifugal force of the rotating substrate W. Note that the main solution A, the additive B, the oxidant C, the etching agent D, and the pure water Wa do not necessarily have to be supplied toward the central part O of the substrate W. It is sufficient to supply them to the same place or substantially the same place on the substrate W. The angles of the discharge nozzles 27A, 27B, 27C, 27D and 27Wa to the substrate can be set as appropriate.

Since the main solution A, the additive B, the oxidant C, the etching agent D, and the pure water Wa in predetermined concentrations and predetermined amounts can be separately supplied onto the substrate W from the discharge nozzles 27A, 27B, 27C, 27D, and 27Wa, respectively, the user can set the concentrations and the discharge amounts of the respective agents on one's own and can appropriately supply them onto the substrate W. The supplied agents become a mixed solution in an appropriate mixing ratio on the substrate W. That is, a mixed solution can be produced on the substrate.

### Liquid Supply Apparatus

This liquid supply apparatus 30 has the same configuration as that of the liquid supplier 20. That is, the liquid supply apparatus 30 includes the first container 21, the second container 22, the third container 23, the fourth container 24, the pure water supply system 25, the mixer 26, the discharge nozzle 27, the heater H1, and the filter F. The first container 21 contains the main solution A. The second container 22 contains the additive B. The third container 23 contains the oxidant C. The fourth container 24 contains the etching agent D. The pure water supply system 25 contains the pure water Wa inside the system. The mixer 26 and the first container 21 are coupled to each other with the main solution supply line L1. The mixer 26 and the second container 22 are coupled to each other with the additive supply line L2. The mixer 26 and the third container 23 are coupled to each other with the oxidant supply line L3. The mixer 26 and the fourth container 24 are coupled to each other with the etching agent supply line L4. The mixer 26 and the pure water supply system 25 are coupled to each other with the pure water supply line L5.

The mixer 26 mixes the main solution A, the additive B, the oxidant C, the etching agent D, and the pure water Wa in predetermined concentrations and predetermined amounts selected in advance to produce a mixed solution. The mixer 26 sends the produced mixed solution to the discharge nozzle 27 via the mixed solution supply line L6. The discharge nozzle 27 supplies the mixed solution onto the substrate W. Note that the main solution A, the additive B, the oxidant C, the etching agent D, and the pure water Wa used in the liquid supply apparatus 30 are the same as those in the liquid supplier 20 described in the first embodiment. The liquid supply apparatus 30 can be, for example, in an existing substrate treatment apparatus, retrofitted to the body of the apparatus as an apparatus to supply a liquid to a substrate or replaced with a previously installed liquid supply apparatus.

### Substrate Treatment Method

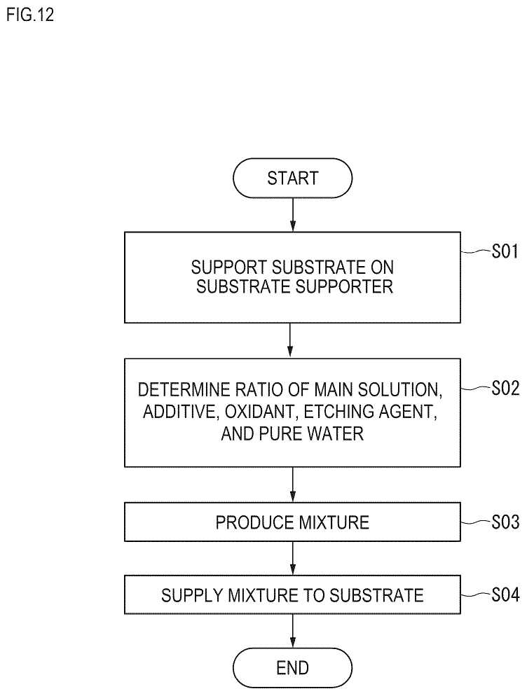

FIG. 12 is a flowchart including an example of a substrate treatment method according to an embodiment. In the present embodiment of the substrate treatment method, the substrate W is first supported on the table 11 of the substrate supporter 10 (S01). A drive source (not shown) of the substrate supporter 10 is driven to rotate the substrate W. Meanwhile, the ratio (mixing ratio) of the main solution A, the additive B, the oxidant C, the etching agent D, and the pure water Wa is determined in order to supply the mixed solution onto the substrate W (S02). For the mixing, the main solution A, the additive B, the oxidant C, the etching agent D, and the pure water Wa, which are the agents, may all be mixed, or necessary agents may be selected and mixed. Next, on the basis of the determined ratio, the agents in predetermined concentrations and predetermined amounts are mixed in the mixer 26 to produce the mixed solution (S03). Subsequently, the produced mixed solution is supplied to the substrate W from the discharge nozzle 27 (S04).

Thus, the present embodiment provides a substrate treatment apparatus, a liquid supply apparatus, and a substrate treatment method that can freely control the agent composition even by the user when the mixed solution required for cleaning treatment, etching treatment, or the like on the substrate is produced and thus optimize cleaning power and etching selectivity for the substrate. In addition, in semiconductor production, even if there are changes of user's demands about residues (substances to be removed) on the substrate, an etching target, etching selectivity, and the like due to changes of process nodes, integration, and the like, the agent composition can be controlled in the apparatus.

Although the embodiments of the present invention have been described above, the technical scope of the present invention is not limited to the aspects described in the embodiments described above and the like. It is clear to those skilled in the art that various changes or improvements can be added to the embodiments described above. Forms with such changes or improvements added are also included in the technical scope of the present invention. For example, although the present embodiment describes the substrate treatment apparatus as a substrate cleaning apparatus, it may be an embodiment in which the mixed solution is supplied to an etching tank of an etching apparatus. Note that one or more of the requirements described in the embodiments described above may be omitted. The requirements described in the embodiments described above can be combined with each other as appropriate. The order of execution of the operations shown in the embodiments can be implemented in any order so long as the results of the previous operation are not used in the subsequent operation. Even if the operations in the embodiments described above are described using “first”, “next”, “subsequently”, and the like for the sake of convenience, it is not essential that they be performed in this order.

### DESCRIPTION OF REFERENCE SIGNS

100, 200, 300, 400 SUBSTRATE TREATMENT APPARATUS
10 SUBSTRATE SUPPORTER
11 TABLE
12 ROTARY SHAFT
20 LIQUID SUPPLIER
21 FIRST CONTAINER
22 SECOND CONTAINER
23 THIRD CONTAINER
24 FOURTH CONTAINER
25 PURE WATER SUPPLY SYSTEM
26 MIXER
27 DISCHARGE NOZZLE
28A FIRST FLOW ADJUSTER
28B SECOND FLOW ADJUSTER
28C THIRD FLOW ADJUSTER
28D FOURTH FLOW ADJUSTER
30 LIQUID SUPPLY APPARATUS
A MAIN SOLUTION
B ADDITIVE
C OXIDANT
D ETCHING AGENT
F FILTER
H1, H2 HEATER
L1 MAIN SOLUTION SUPPLY LINE
L2 ADDITIVE SUPPLY LINE
L3 OXIDANT SUPPLY LINE
L4 ETCHING AGENT SUPPLY LINE
L5 PURE WATER SUPPLY LINE
T BUFFER TANK
V, V1, V2, V3, V4 MIXING VALVE
Wa PURE WATER

What is claimed is:

1. A substrate treatment apparatus, comprising:
a substrate supporter that supports a substrate; and
a liquid supplier that supplies a liquid to a surface of the substrate supported by the substrate supporter,
wherein the liquid supplier supplies the substrate with a mixed solution prepared in a predetermined ratio of a main solution, pure water, and one or more agents selected from the group consisting of an additive, an oxidant, and an etching agent.

2. The substrate treatment apparatus according to claim 1, wherein the liquid supplier includes:
a first container that contains the main solution;
a second container that contains the agent; and
a supply system for pure water, and
prepares the main solution taken out of the first container, the agent taken out of the second container, and pure water from the supply system in a predetermined ratio.

3. The substrate treatment apparatus according to claim 2, wherein one or both of the first container and the second container are replaceable.'

4. The substrate treatment apparatus according to claim 1, wherein the liquid supplier includes:
a first flow adjuster that sets a flow per unit time of the main solution;
a second flow adjuster that sets a flow per unit time of the agent; and
a supply system for pure water, and
sets each of the first flow adjuster, the second flow adjuster, and a pure water flow by the supply system to prepare the main solution, the agent, and pure water in a predetermined ratio.

5. The substrate treatment apparatus according to claim 1, wherein, in the liquid supplier, a plurality of main solutions are prepared, one or more of which may be selected.

6. The substrate treatment apparatus according to claim 1, wherein the main solution is a solution in which pure water, an organic solvent, a pH adjuster, a corrosion inhibitor, a chelating agent, a surfactant, and a reaction accelerator are mixed.

7. The substrate treatment apparatus according to claim 1, wherein, in the liquid supplier, a plurality of the additives are prepared as the agent, one or more of which may be selected.

8. The substrate treatment apparatus according to claim 1, wherein the additive contains at least one of an organic solvent, a pH adjuster, a corrosion inhibitor, a chelating agent, a surfactant, and a reaction accelerator.

9. The substrate treatment apparatus according to claim 1, wherein the additive is diluted with the main solution.

10. The substrate treatment apparatus according to claim 1, wherein, in the liquid supplier, a plurality of the oxidants are prepared as the agent, one or more of which may be selected.

11. The substrate treatment apparatus according to claim 1, wherein the oxidant contains either a peroxide or an oxoacid.

12. The substrate treatment apparatus according to claim 1, wherein, in the liquid supplier, a plurality of etching agents are prepared as the agent, one or more of which may be selected.

13. The substrate treatment apparatus according to claim 1, wherein the etching agent contains at least one selected from the group consisting of a hydrogen halide, a hydrogen halide compound, and a base compound.

14. The substrate treatment apparatus according to claim 1, wherein the liquid supplier includes a buffer tank into which the main solution, the agent, and pure water in respective predetermined amounts are charged to produce the mixed solution before supplying to the substrate.

15. The substrate treatment apparatus according to claim 1, wherein the liquid supplier includes a mixing valve to mix the main solution, the agent, and pure water before supplying to the substrate.

16. The substrate treatment apparatus according to claim 1, wherein
when the liquid supplier prepares the main solution, the additive, the oxidant, the etching agent, and pure water in a predetermined ratio to produce the mixed solution,
the predetermined ratio is the main solution:the additive:the oxidant:the etching agent:pure water is 1 to 100:0 to 100:0.1 to 100:0.1 to 100:1 to 100.

17. The substrate treatment apparatus according to claim 1, wherein
the liquid supplier includes a plurality of discharge nozzles that respectively supply the substrate with the main solution, the agent, and pure water, and
the discharge nozzles supply the main solution, the agent, and pure water in respective predetermined flows to the same or substantially the same location on the substrate to produce the mixed solution prepared in a predetermined ratio on the substrate.

18. A liquid supply apparatus that supplies a liquid to a surface of a substrate supported by a substrate supporter, wherein
the liquid supply apparatus supplies the substrate with a mixed solution prepared in a predetermined ratio of a main solution, pure water, and one or more agents selected from the group consisting of an additive, an oxidant, and an etching agent.

19. A substrate treatment method comprising:
producing a mixed solution prepared in a predetermined ratio of a main solution, pure water, and one or more agents selected from the group consisting of an additive, an oxidant, and an etching agent; and
supplying the mixed solution to a substrate supported by a substrate supporter.
